(19) United States
(12) Patent Application Publication
(10) Pub. No.: US 2009/0279760 A1
(43) Pub. Date: Nov. 12, 2009

(54) METHOD FOR DISPLAYING MEASUREMENTS AND TEMPORAL CHANGES OF SKIN SURFACE IMAGES

(76) Inventor: Harris L. Bergman, Smyma, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/466,413

(22) Filed: May 15, 2009

Related U.S. Application Data
(63) Continuation of application No. PCT/US2007/084974, filed on Nov. 16, 2007.

(51) Int. Cl. G06T 7/00

(52) U.S. Cl. 382/128

(57) ABSTRACT

A method and system can provide a way for a person to objectively screen himself or herself for increased skin cancer risks using ABCD parameters in conjunction with a digital photograph and a computer. A digital photograph of a skin lesion can be obtained and the lesion can be segmented from the image. Next, several features of the lesion can be measured and these measurements can be displayed graphically in a manner which is understandable to a user who may not have any medical training.

### CROSS REFERENCE TO RELATED APPLICATION FOR WHICH A BENEFIT IS CLAIMED UNDER 35 U.S.C. §119(e)

This patent application claims priority under 35 U.S.C. §119(e) to U.S. Provisional Patent Application No. 60/866,321, entitled “Method for Displaying Measurements and Temporal Changes of Skin Surface Images,” filed Nov. 17, 2006. The complete disclosure of the above identified priority application is hereby fully incorporated herein by reference.

### FIELD OF THE INVENTION

The present inventive method and system relates to medical devices and in particular a method for displaying measurements and temporal changes of skin surface images.

### BACKGROUND OF THE INVENTION

There has been a steady increase in the incidence of malignant melanoma and other skin cancers in the United States and abroad. According to the American Cancer Society, over one million new cases of skin cancer will be diagnosed in the United States. Over ten thousand Americans—and six times as many worldwide—will die of skin cancer this year. Early detection is key to surviving skin cancer.

Dermatologists have devised several tests to identify skin cancer visually. Perhaps the most well-known is the ABCD system. The ABCD system of identifying skin cancer involves checking for asymmetry (A), border irregularities (B), color (C) variegation, and diameter (D) and finds about 80% of skin cancers with a specificity of 80% as well. It has been found that changes in skin characteristics, such as physical changes in a mole's appearance, are useful in diagnosing skin cancer. Consequently, the Seven-Point Checklist was developed. In the Seven-Point method, the observer looks for three major signs (changes in size, shape and color) and four minor signs (the presence of inflammation, crusting or bleeding, and a diameter of 7 mm or greater). A significant change from any one of the major signs or having any three of the minor signs without changes warrants close scrutiny. The primary problem with the seven-point checklist is in remembering what a skin lesion looked like several months prior to an exam.

New technology called epiluminescence microscopy (ELM) can examine deeper into the skin than can be done with natural light and reveal features not visible to the naked eye. When used by a trained dermatologist, ELM improves sensitivity and specificity to 90% and above. Though ELM is superior to natural light, it is still interpreted subjectively and due to the actual process of performing the test, is subject to variability.

Photographic systems have been developed to make historical records of skin lesions. Furthermore, several researchers have attempted to build artificial intelligence software that can completely diagnose skin cancer from photographs, ELM, or other lighting systems. One of these systems claims to be 98% sensitive and specific. Unfortunately it requires specifically designed hardware. The limitation to any system that claims to diagnose a disease or condition is that it will be subject to regulatory approval. The FDA Premarket Approval (PMA) process for such products can be lengthy and expensive.

The aforementioned technologies only benefit people that visit a dermatologist. In the case of skin cancer, that visit often comes too late. That is why dermatologists and the popular media tell the public to perform skin self-exams. Specifically, people are taught to look for the ABCDs of skin cancer. The major problem with self-administered ABCD exams is that the public generally doesn't have a good way of quantifying the ABCDs or interpreting the results. For example, the public is told that moles with a diameter greater than 6 mm are suspicious; however, few people take a ruler to their skin or know the size of a millimeter. Additionally, having the public just look at their skin with their eyes for the ABCDs annually does not allow people to measure changes that may take place.

### SUMMARY OF THE INVENTION

An inventive method and system can provide a method for the general public to objectively screen themselves for skin cancer using the ABCD parameters in conjunction with a digital photograph and a computer. A digital photograph of a skin lesion can be obtained and the lesion can be segmented from the image. Next, several features of the lesion can be measured and these measurements can be displayed graphically.

This system can enable the layperson to perform a quantitative skin self-exam and understand the significance of the quantities that are measured through the unique graphical display of the measured quantities. Not only can the graphical display of the measurements indicate that there are high-risk visual characteristics or changes to a person's skin that should be seen by a physician immediately, the results can also show that one or more skin lesions are of low-concern, thereby saving time and money from an unnecessary doctor visit. By saving the results, the layperson can also observe the change over time of a mole's characteristics. Furthermore, these changes include the major signs in the more sensitive Seven-Point Checklist. Users of the system can take hard copies of the digital photograph and the measurements to their licensed health care professional, such as a physician, for expert analysis and diagnosis.

One benefit to this inventive method and system over other devices is that it assists users to quantitatively measure skin change(s) using an off-the-shelf digital camera and software that performs functions that can be found in off-the-shelf software such as Adobe Photoshop. In other words, the inventive method and system is intended to only provide a user with a way to measure change(s) in skin lesions in a very precise manner. The inventive system is not intended for use in the diagnosis of skin disease or other conditions, or in the cure, mitigation, treatment, or prevention of skin disease, in man or other animals. When any measured changes in skin lesions are significant, the inventive method and system can recommend that the user seek advice and diagnosis from a licensed health care professional.

As such, the inventive method and system will likely not need any governmental regulatory oversight whatsoever. However, if this inventive method and system were deemed by a regulatory body, such as the U.S. Food And Drug Administration (FDA), to fall under the federal regulatory approval as an Image Processing System (21 CFR 892.2050), then the inventive method and system would likely require only proving substantial equivalence to other image processing applications in which no clinical trials are required.

Many aspects of the invention will be better understood with reference to the above drawings. The elements and features shown in the drawings are not to scale, emphasis instead being placed upon clearly illustrating the principles of exemplary embodiments of the present invention. Moreover, certain dimensions may be exaggerated to help visually convey such principles. In the drawings, reference numerals designate like or corresponding, but not necessarily identical, elements throughout the several views.

### BRIEF DESCRIPTION OF DRAWINGS

FIG. 1A illustrates a person's arm on which there is a skin lesion, according to one exemplary embodiment of the invention.

FIG. 1B illustrates a flowchart of an overview of the method and system according to one exemplary embodiment of the invention.

FIG. 2 illustrates a sample user interface (UI) according to one exemplary embodiment of the invention.

FIG. 3 illustrates a user interface with images of the same lesion of FIG. 2 taken from two different times may according to one exemplary embodiment of the invention.

FIG. 4 illustrates a variation on the presentation of results from different times according to one exemplary embodiment of the invention.

FIG. 5 illustrates a user interface with a legend according to one exemplary embodiment of the invention.

FIG. 6 illustrates color-coded bars for the ABCD parameters in the UI combined with labels according to one exemplary embodiment of the invention.

FIG. 7 illustrates a different graphical ABCD measurement display according to one exemplary embodiment of the invention.

FIG. 8 illustrates how data can be scaled according to one exemplary embodiment of the invention.

FIG. 9 illustrates a way of presenting the confidence interval of the parameters in a case where one point in time is being studied according to one exemplary embodiment of the invention.

FIG. 10 illustrates a fuel gauge display according to one exemplary embodiment of the invention.

FIG. 11A illustrates a probability density function according to one exemplary embodiment of the invention.

FIG. 11B illustrates a graph of the likelihood of malignancy (LM₂) given the PDFs of FIG. 11A according to one exemplary embodiment of the invention.

FIG. 12A illustrates a graphical bar that may represent the LM for a particular measurement according to one exemplary embodiment of the invention.

FIG. 12B illustrates a more conservative approach to converting the LM estimate to a graphical display according to one exemplary embodiment of the invention.

FIG. 13A illustrates a linearized LM curve according to one exemplary embodiment of the invention.

FIG. 13B illustrates an alternate approach to determining a tangent line according to one exemplary embodiment of the invention.

FIG. 14 illustrates the mapping of X to position of the marker in the bar according to one exemplary embodiment of the invention.

FIG. 15 illustrates a flowchart of the basic process by which the ABCDs of skin cancer are displayed from a digital image of the skin according to one exemplary embodiment of the invention.

FIG. 16A illustrates a technique for thresholding in a region of interest around the lesion then smoothing the boundary according to one exemplary embodiment of the invention.

FIG. 16B illustrates a more sophisticated technique of segmenting a lesion that is typically less prone to noise according to one exemplary embodiment of the invention.

FIG. 17 illustrates a flowchart showing the details of how the ABCDs of skin cancer are measured in a routine of FIG. 15 according to one exemplary embodiment of the invention.

FIG. 18 illustrates an overview of a more sophisticated implementation of the method and system according to one exemplary embodiment of the invention.

FIG. 19 illustrates additional steps that can added to the basic flowchart according to one exemplary embodiment of the invention.

FIG. 20 illustrates comparing multiple images of a mole over time and an E parameter that can be derived from the amount of change in ABC and D in the time interval according to one exemplary embodiment of the invention.

FIG. 21A illustrates an internet based implementation between a local computer and a networked computer or server according to one exemplary embodiment of the invention.

FIG. 21B illustrates an implementation where a digital picture is acquired at one location of FIG. 21A and then is uploaded to a web or application server according to one exemplary embodiment of the invention.

In FIG. 21C illustrates a web application or applet which can be downloaded from a server to a computer according to one exemplary embodiment of the invention.

FIG. 22 illustrates a user interface in which the parameters are graphically explained according to one exemplary embodiment of the invention.

### DESCRIPTION OF THE PREFERRED EMBODIMENTS

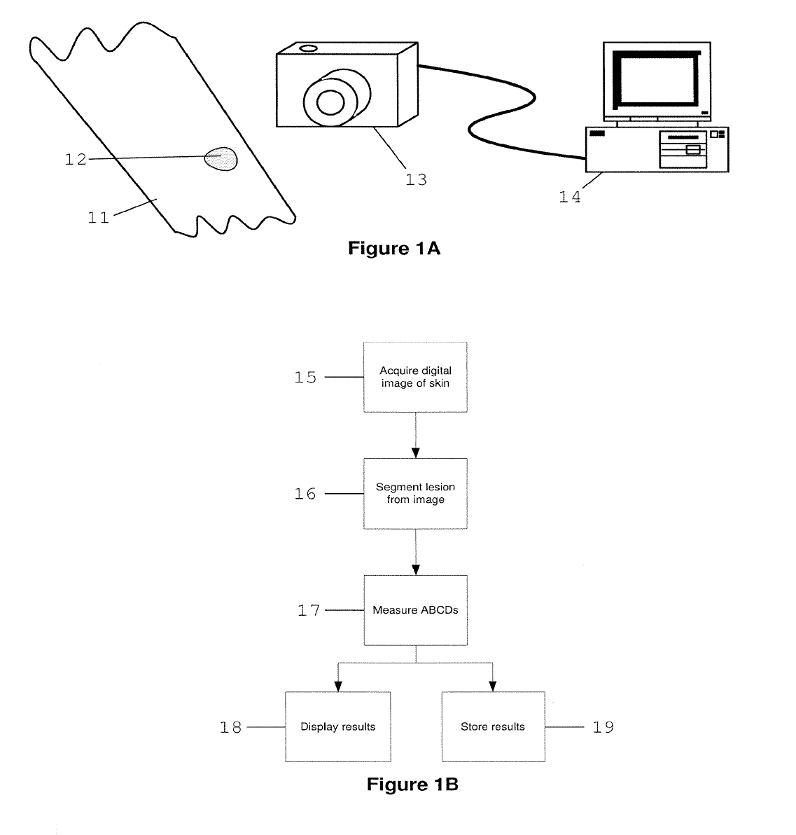

FIG. 1A shows a representation of a person's arm 11 on which there is a skin lesion, such as a mole, 12. A camera 13 is used to acquire a digital image of the skin; the image contains a lesion to be analyzed and perhaps additional lesions. The digital image is transferred to a computer 14. The drawing shows a cable connection between the camera and computer; however, they need not be connected. The photographs may be stored in the camera's memory and the digital images then transferred to the computer through any variety of means (wireless connection, flash memory card, Internet, etc.) at a later date. Furthermore, the camera and computer need not be separate devices. The inventive method and system can be embodied in a handheld device with a camera, microprocessor and display, such as a PDA. In the case where a film-based camera is used, a photograph can be digitized with a scanner and transferred to a computer.

Referring to FIG. 1B, a flowchart shows an overview of the inventive method and system. A digital image of a skin lesion is obtained in step 15. Software can segment the lesion from the rest of the image in step 16. Next in step 17, the ABCDs (Asymmetry, Border, Border irregularities, Color variegation, and Diameter) of the lesion are measured. Lastly, the ABCD measurements are displayed graphically in step 18. Step 19 shows that these measurements may also be stored for later use; storage may be in a computer 14, another device (flash memory, other computer), or even uploaded to a website.

The system allows a person to take a picture of their skin and have the ABCDs of skin cancer objectively measured and displayed in an easy-to-understand fashion. By displaying features that may be suspicious in the self-exam, the inventive method and system and method can identify characteristics of the skin that would be of interest to a medical professional, such as a physician.

In order to determine the diameter, either 1) there is some reference in the image with known dimensions or 2) the distance from the camera to the skin and information about the camera must be known. In the case where neither condition is met, the D parameter is unknown and will not be displayed.

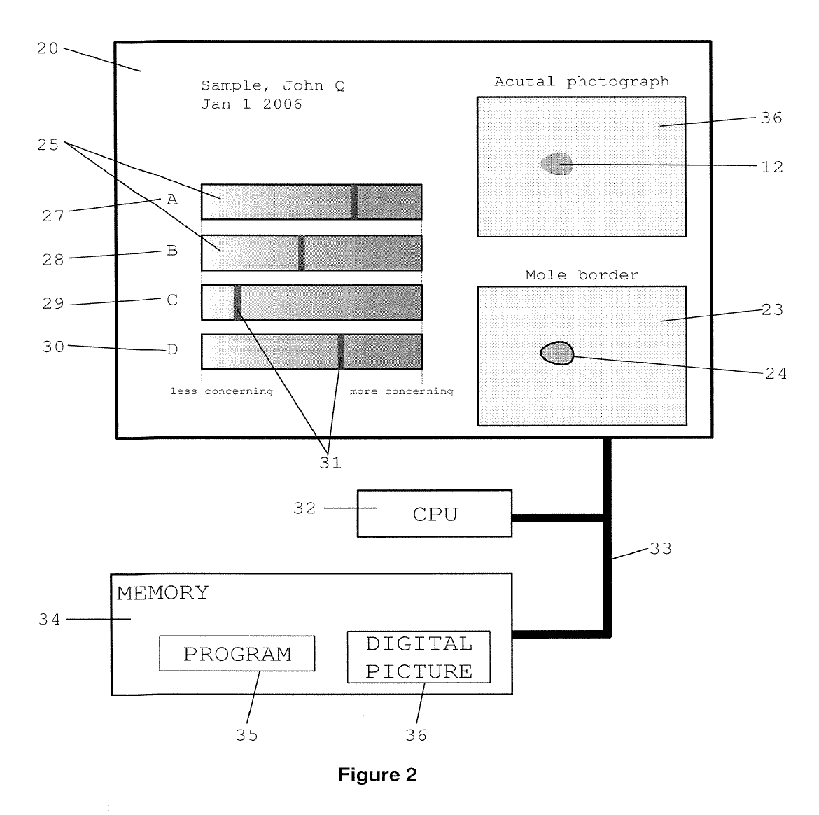

FIG. 2 shows a sample user interface (UI) 20, and how it relates to a computing device and memory 34. When the CPU 32 runs a program 35 embodying the inventive method and system, processing the skin image(s) 36, it results in the graphical display of the ABCD parameters of skin cancer (27-30). For each of the four measurements, a color-coded bar 25 is displayed. The color varies from one side to the other. FIG. 2 presents these bars 25 in grayscale; however, a person with ordinary skill in the art recognizes that these bars can be represented in color or grayscale or a combination thereof. This substitution of grayscale in the drawings with colors of corresponding brightness and hue is applicable to all Figures in this document. The use of the word “color” in this document includes all colors, including grayscale.

One side of the bar (e.g., the left side) represents less-concerning measurements and can have a corresponding color, such as green. The other side of the bar (e.g., the right side) represents more-concerning measurements and can have a corresponding color, such as red. In one such exemplary embodiment, the former color is green and the latter, red. The colors vary from one to the other from one side to the next. Note that grayscales may be used instead of color. A marker 31 corresponding to the particular measurement is positioned inside the bar based on what datum the sides of the bar represent. For example, the marker representing Diameter may be scaled to start at 1 mm at the less-concerning side and end at 6 mm for the more-concerning side. A Diameter measurement of 4 mm would place the marker closer to the more-concerning side. Other elements of the UI include demographic and date information, a view of the digital image being measured 36 with its lesion 12, and a processed view 23 showing the margins 24 of the lesion after segmentation (the process of separating an image into different objects, for example, skin lesion(s) and non-skin lesion).

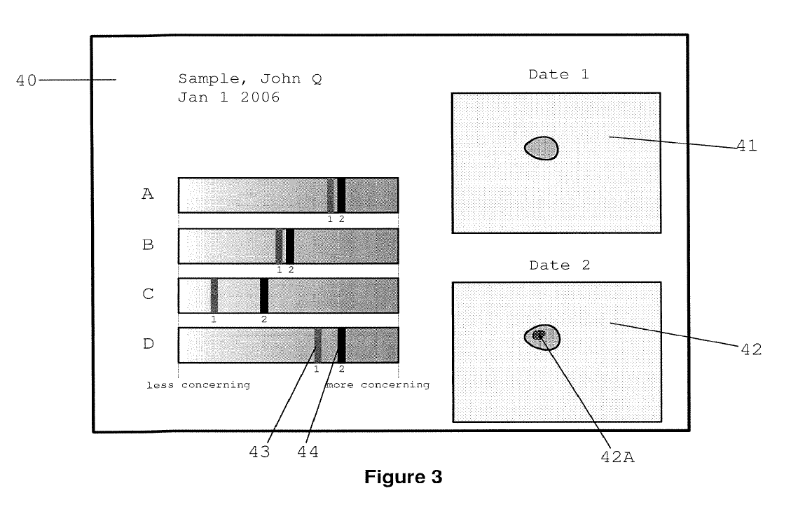

Identifying change in appearance is an important aspect of monitoring a lesion for cancer. FIG. 3 shows a user interface 40 with images of the same lesion taken from two different times may be displayed simultaneously. The original or processed image 41 from the earlier date, Date 1, is displayed, as is the original or processed image 42 from the later date, Date 2. The displays of the ABCD parameters are modified to include two markers in each bar-one marker for each image (point in time). In this manner, the graphical display of the ABCD parameters can make it easier to tell if the lesion is becoming more or less concerning. The first D, marker 43, corresponds to Date 1 and the second D marker 44, corresponds to Date 2. The two markers can have different colors and/or have labels under them to help identify to which image they correspond.

This method of display can be extended to additional images (Date 3, Date 4, and so on). For example, if a lesion was originally of uniform color at the first Date 1, then later developed a patch 42A of a different color by second Date 2, the markers on the bar for Color would show a shift to the more concerning side. In the drawing, there is a numeral under each marker indicating which date the marker represents.

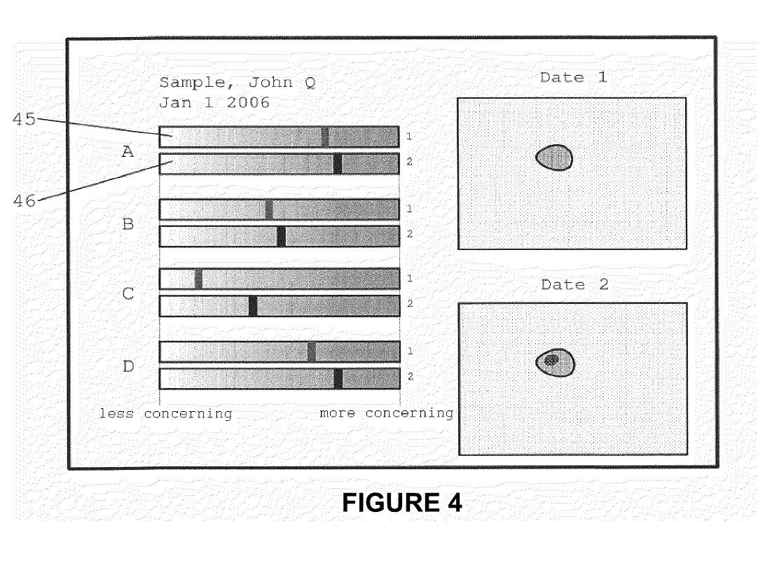

FIG. 4 illustrates a variation on the presentation of results from different times. For each of the measurements to be displayed, there are multiple color-coded bars—one for each date. In the example, the upper color-coded bar 45 provides the results for the A parameter for the earlier date (Date 1) and the lower color-code bar 46 provides the results for the A parameter for the later date (Date 2). This concept can be extended to show additional bars for each ABCD parameter, such as three bars if there were three sets of results to be presented.

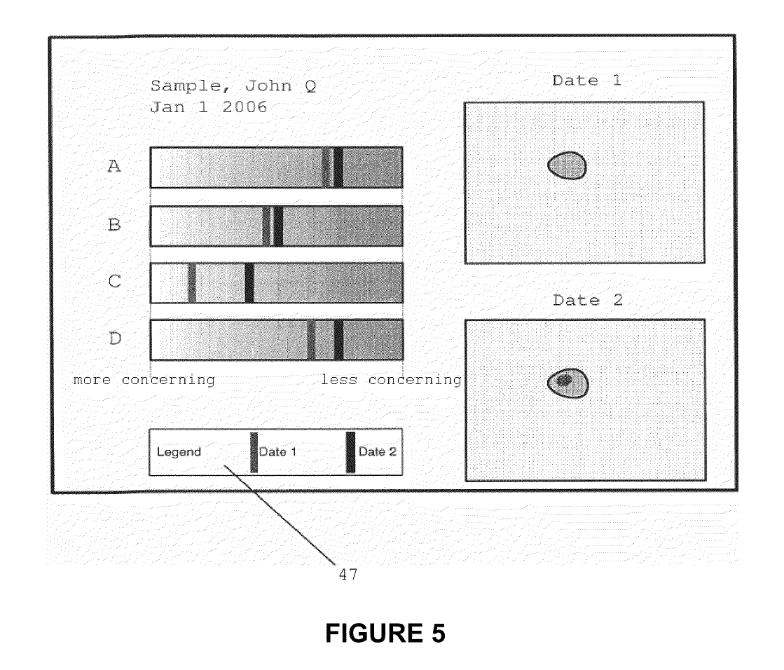

In FIG. 5, a legend 47 is added to the user interface. The labels in the legend indicate for which dates the markers correspond. Including a legend makes individually labeling the markers unnecessary. There are many other ways to indicate which marker is for a particular date, such as (but not limited to) making the marker be the date itself.

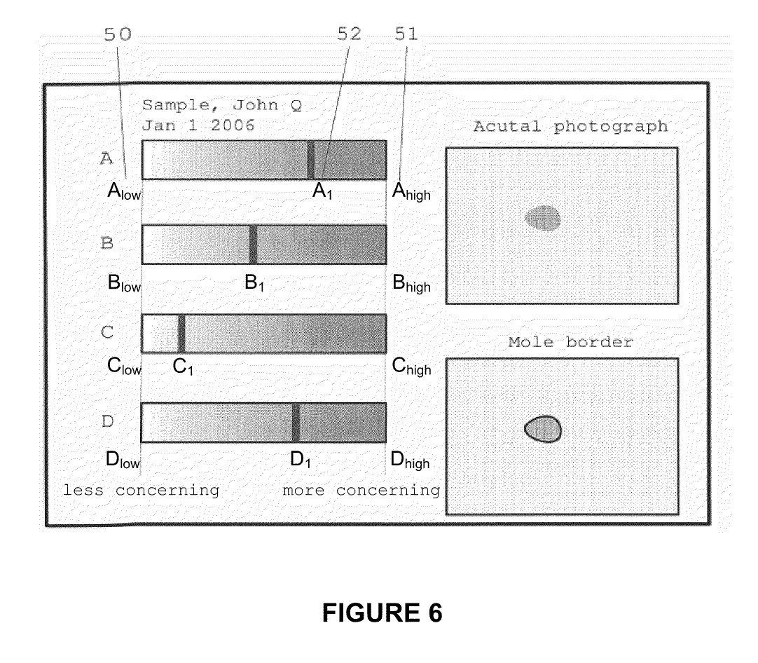

FIG. 6 illustrates the color-coded bars for the ABCD parameters in the UI with labels. On each side of the bar, there are labels for the values of the low 50 and high 51 ends of the range of results. The value of the measurement 52 is listed near the marker (though the measurement value could be listed elsewhere). For example, the Diameter bar could have a range from 2 mm (D_{low}) to 20 mm (D_{high}). This concept can be extended to measurements from multiple dates.

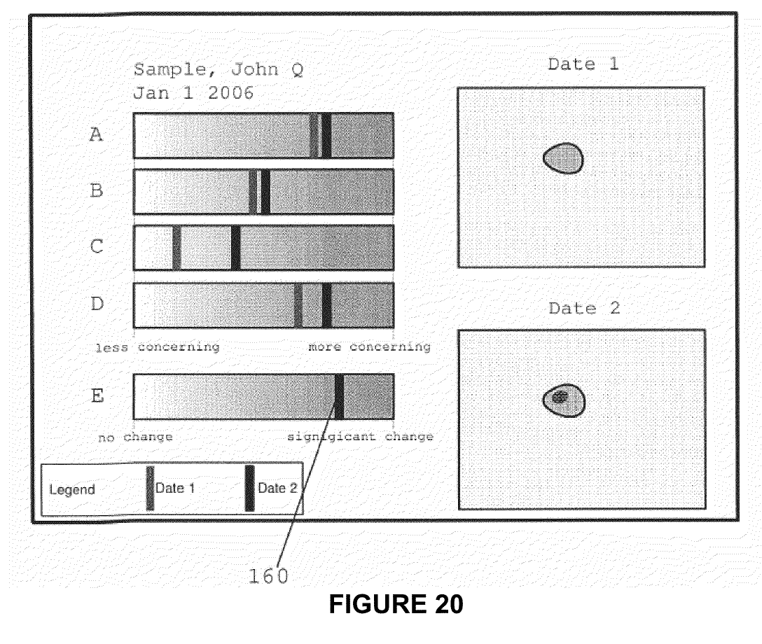

The labels and the range for which the bars correspond need not correspond to raw measurements (such as the diameter). They can also represent derived statistics, such as percent change (when comparing multiple images) or likelihood of disease. FIG. 20 illustrates a user interface where a fifth parameter E (evolution) has been added. Marker 160 can be the sum of the percent changes in parameters A, B, C, and D between Dates 1 and 2.

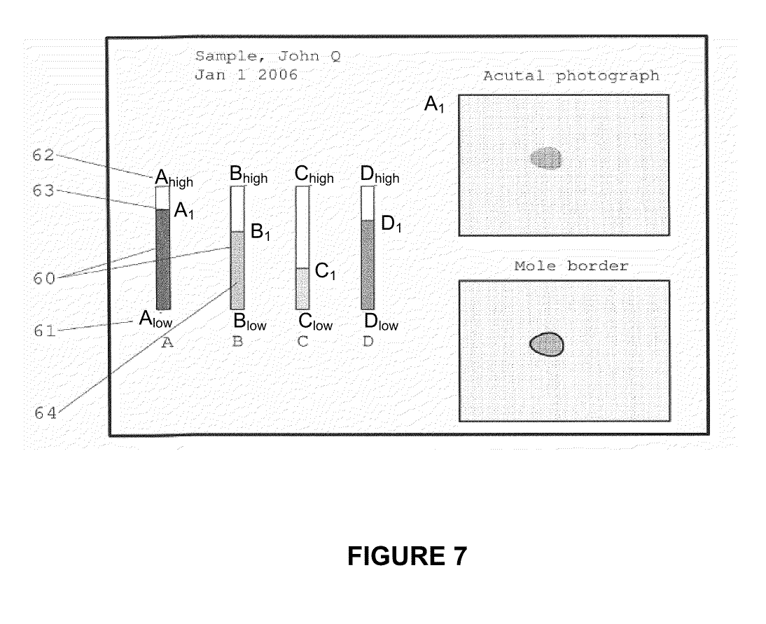

In FIG. 7, a different graphical ABCD measurement display is shown. This display uses a thermometer metaphor to present the ABCD parameters. For each of the parameters, there is a vertical bar 60. The bottom of the bar 61 represents the low end of the ABCD parameter's display range; the top, 62, the high end. Somewhere between (and inclusive) of the bottom and top of the bar is the value of the variable 63. Below this value, the bar is filled-in (or simply a different color from that of the “empty” bar). To further illustrate the relative concern of any of the measurements, the filled-in section of the bar 64 can be color-coded in a manner similar to that described earlier: shorter filled-in bars have lower concern and are in shades of green, longer filled-in bars have increasingly greater concern and their color shifts towards red. The values of the ends of the bars and the variable may or may not be displayed. They are shown in the figure for reference.

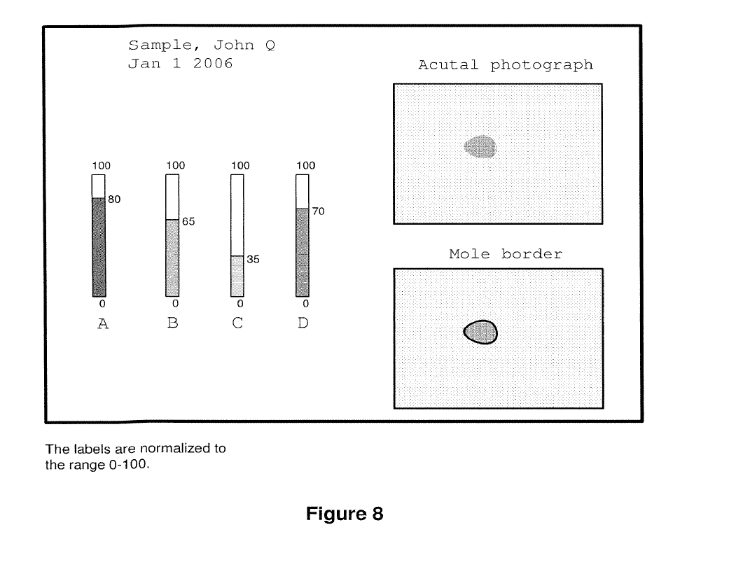

Rather than display the actual values of the measurements, and the low and high ends of the display ranges—something that may have little relevance to the layperson—the data can be scaled in a range of 0 to 100, as shown in FIG. 8. For example, the A parameter, asymmetry of the lesion, could be scaled from 0 (completely asymmetric, such as a linear scar from a cut) to 100 (a perfectly round, consistently dense freckle). This approach can also be applied to the methods of display described herein.

Also, the width of the markers can correspond to the confidence interval of the measurement. The confidence interval is also known as margin of error (e.g., the “plus or minus” statistic often seen as a footnote on polls). In the general case of displaying a parameter that corresponds to a single measurement of a skin lesion, the confidence interval is the value of that measurement plus or minus:

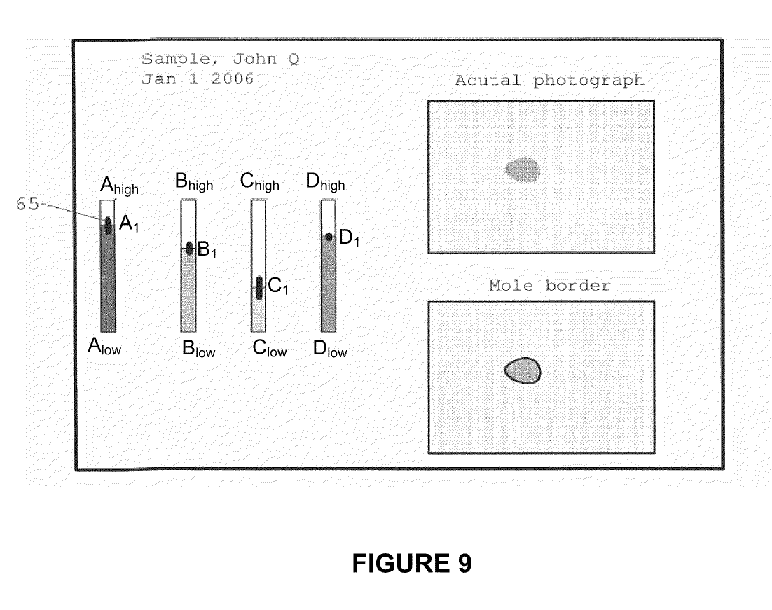

z_{α/2}·σ

where z is the standard normal probability density function, 1-a is the degree of confidence (e.g., 95% certainty), and σ is the standard deviation of the particular parameter (ascertained by clinical data). Note that there will be a different confidence interval for each parameter due to their having different standard deviations. FIG. 9 illustrates a way of presenting the confidence interval of the parameters in the case where one point in time is being studied. Error bars 65 can be placed above and below the top of the filled-in part of the bar. In the case where multiple points in time are being presented, it may be observed that the error bars overlap for a parameter between the dates. Generally speaking, this means that the change in the value of that parameter did not change in a statistically significant way.

Images taken from different times can be compared by placing these “thermometer” bars side-by-side, much like the means described in FIG. 4. The A variable from the earliest time is on the left, then comes the next sequential A variable. Then the B variables, and so on.

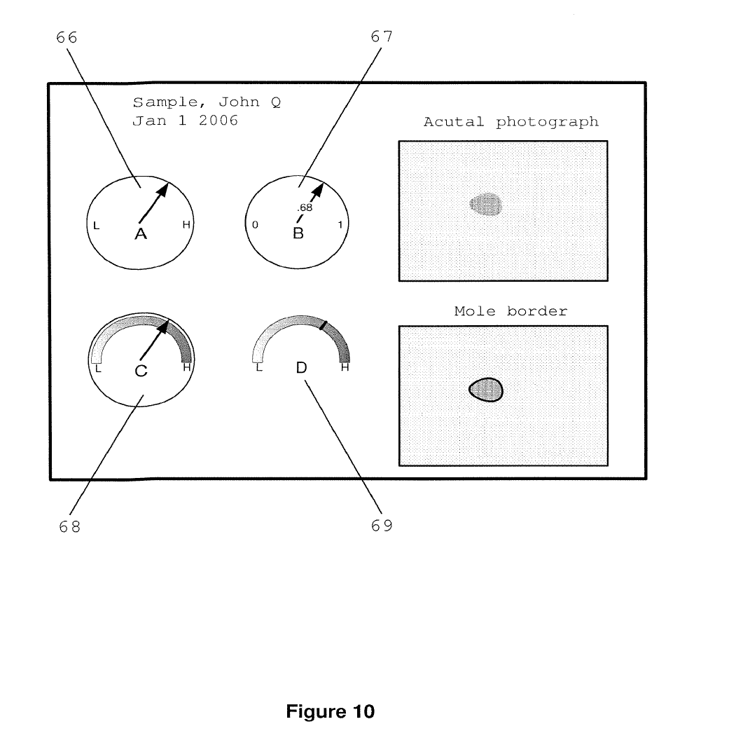

FIG. 10 presents UI: a “fuel gauge” metaphor. There are four styles shown. In gauge 66, the needle is between a L (“low concern”) and H (“high concern”) marker. Gauge 67 replaces the L and H with 0 and 1, respectively, plus (optionally) adds a value for the variable by the arrow. The L and 0 can be colored green and the H and 1 colored red to illustrate the relative risk. The arrows can be colored based on where in between the ends the measurement falls. A color-varied arc is added to the gauge 68. In gauge 69, the presentation is like that in FIG. 2, only the bar is in the shape of an arc.

One important aspect of the inventive method and system is determining the low and high values of the variables. In general, these variables are not evenly distributed in the range of 0 to 1, or even 0 to 10 or 100. The movement of the markers in the bars needs to correspond relevantly to the degree of “good” or “bad.” The major benefit of this way of displaying the results is to give the layperson an easy way of understanding if any of the ABCDs are less- or more suspicious. Consequently, the range of each of the variables (e.g., D_{low} to D_{high}) should span the region where the concern moves from less suspicious to more suspicious. That means that if the marker is in the middle of the bar, the degree of concern should be moderate. The way this can be performed is by analysis of clinical data.

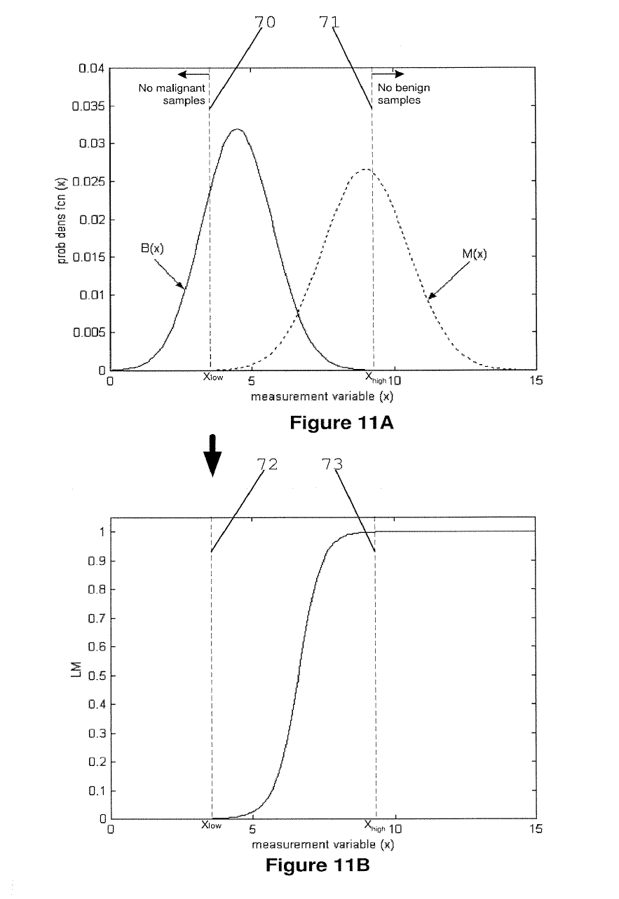

In statistics, a probability density function (PDF) shows the probability of an event as a function of some variable X. One may recall “bell-curve” graphs as a typical example of a PDF. In this case, we are concerned with the probability that a skin lesion is malignant (or having some other disease condition) or benign, as a function of A, B, C, and D. These data can be obtained through clinical research of skin lesions that were photographed before being biopsied. FIG. 11A illustrates demonstrates these functions. B(x) is the PDF of those lesions that were proven to be benign. (Note that in this discussion, X may be one of the A, B, C, D, or E parameters). M(x) is the PDF of those lesions that were proven to be malignant. As can be seen in the figure, there are no malignant lesions that have a value of X less than the point 70 on the x-axis X_{low} and there are no benign lesions that have a value of X greater than the point 71 on the x-axis X_{high}. This is this range—from X_{low} to X_{high}—that is to be represented in the bars in the UIs.

There are likely to be a few outliers that could move X_{low} far to the left and X_{high} to the right. From a practical standpoint, X_{low} can be defined as the point where the area to the left under the M(x) curve is 1% or 0.1%, not 0%. Likewise with X_{high}.

Another way of looking at the meaning of the placement of the marker in the bars is to consider the likelihood of malignancy (LM) as a function of the measurement variable X. Since we know, though clinical data, the functions B(X) and M(X), Bayes' theorem shows that the statistical likelihood of malignancy of some new lesion, as a function of X, is:

$${LM}_{1} = \frac{pM ( X )}{pM ( X ) + ( 1 - p ) B ( X )} \qquad ( Eq . 1 )$$

where p is the prevalence of the disease in the population.

The drawback to Eq. 1 is that p is generally small; consequently the likelihood of malignancy calculated from the equation is also generally small. In the clinical setting, a patient typically does not care about prevalence but rather what is occurring to his or her individual situation. If we consider the Maximum-Likelihood of a positive outcome without regards to prevalence, one can remove prevalence from Eq. 1 and produce a more aggressive (i.e., higher) estimate of the likelihood of malignancy:

$${LM}_{2} = \frac{M ( X )}{M ( X ) + B ( X )} \qquad ( Eq , 2 )$$

FIG. 11B displays a graph of the likelihood of malignancy (LM₂) given the PDFs in FIG. 1A. The LM curve is sigmoidal (or s-shaped), zero below X_{low} 72, and one (i.e. 100%) above X_{high} 73. Note that points 70 and 72 are the same value, and points 71 and 73 are the same value.

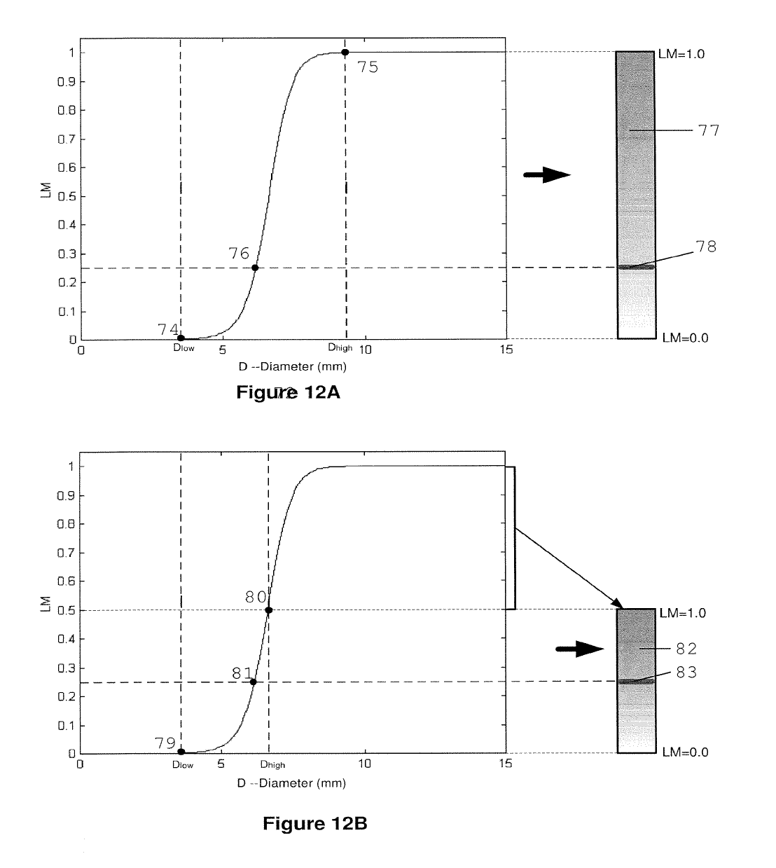

There are several techniques for displaying the likelihood of malignancy graphically. As illustrated in FIG. 12A, the graphical bar may simply represent the LM for a particular measurement. For example, suppose the variable X represents the diameter parameter, D. For D less than or equal to D_{low} 74, the LM is zero, which represents the low end (LM=0.0) of the color-coded bar 77. For D greater than or equal to D_{high} 75, the LM is 1, which represents the high end (LM=1.0) of the color-coded bar. Suppose in one case, the diameter of a skin lesion is 6 mm. As can be seen at point 76, the LM for lesions with a 6 mm diameter is about 0.25. Consequently the marker 78 is placed one quarter of the way up the bar. When the results are presented in a manner such as that of FIG. 2 (where the orientation of the bars has been rotated 90 degrees clockwise from that of FIGS. 12A and 12B), marker 31 would be one quarter of the distance from the left side of the horizontally oriented bar.

FIG. 12B shows a more conservative approach to converting the LM estimate to a graphical display. As with FIG. 12A, for D less than or equal to D_{low} 79 in FIG. 12B, the LM is zero, which represents the low end of the color-coded bar 82. The top of the color-coded bar represents any LM estimate greater than or equal to 0.5, the likelihood of malignancy at point 80. In the example, the diameter measurement of 6 mm, with LM of 0.25 at point 81, would produce a marker 83 roughly in the middle of the color-coded bar 82.

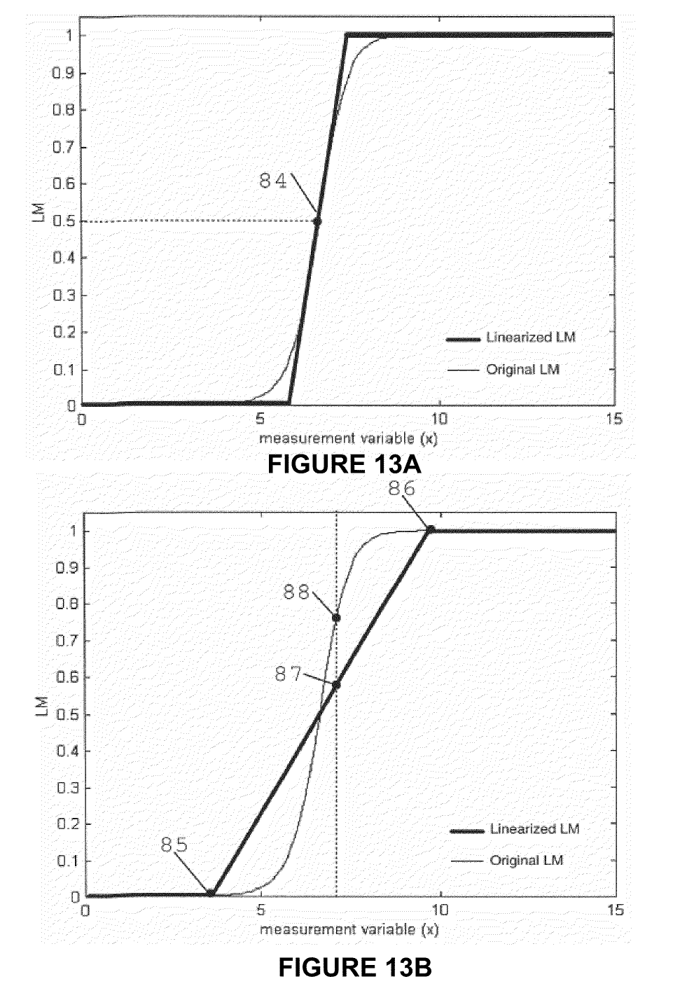

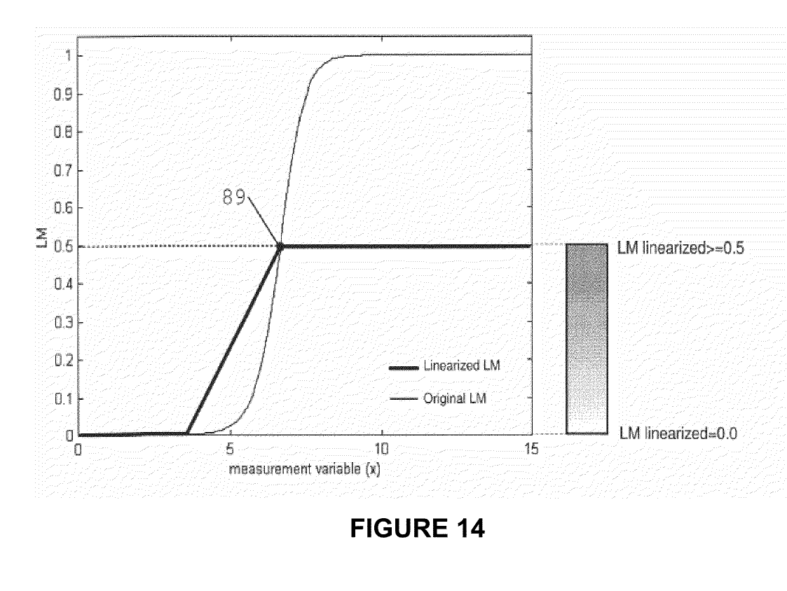

A drawback to the approach illustrated in FIG. 12 is that the marker does not move linearly with the value of X. It moves in a sigmoidal (s-shaped) manner, in much the same as a car's fuel gauge. It starts moving slowly then moves more quickly in the middle. The layperson could find this disconcerting, especially if the graphical display shows the values of the variable (refer to FIG. 6). Consequently, the LM curve can be linearized as illustrated in FIG. 13 and FIG. 14. In FIG. 13A, the linearized LM curve is defined as a line tangent to the original (true) LM curve at LM=0.5 at point 84. This line is a good fit to the original curve; however, it underestimates LM for small X. Considering this inventive method and system may be used for screening for cancer, that underestimation can be problematic. An alternate approach to determining the line is to start it at X_{low} 85 and end it at X_{high} 86, as illustrated in FIG. 13B. While the line does not fit the original LM curve as well as the tangent, it conservatively overestimates LM at low X. Unfortunately, the line dramatically underestimates LM at higher X. For example, in FIG. 13B, at X=7, the linearized LM is about 0.6 at point 87 but the original LM curve is about 0.75 at point 88. Again, erring on the side of conservatism, the mapping of X to position of the marker in the bar can be limited to LM<=0.5, as shown by point 89 in FIG. 14.

Certain steps in the processes or process flow described in all of the logic flow diagrams referred to below must naturally precede others for the invention to function as described. However, the invention is not limited to the order or number of the steps described if such order/sequence or number does not alter the functionality of the present invention. That is, it is recognized that some steps may not be performed, while additional steps may be added, or that some steps may be performed before, after, or in parallel other steps without departing from the scope and spirit of the present invention.

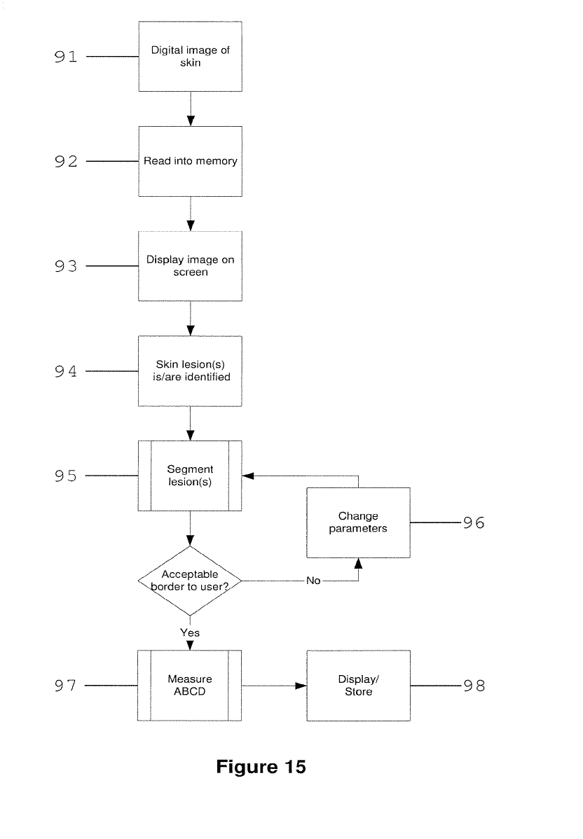

FIG. 15 presents a flowchart of the basic process by which the ABCDs of skin cancer are displayed from a digital image of the skin. In step 91, a digital image of the skin is acquired either directly by a digital camera or indirectly by scanning a photograph. The image is read into memory, which could be performed through a cable to a camera, over the internet, reading a memory card, or directly from a digital camera integrated in a computing device, as represented in step 92. The image is displayed for a user to view (optional) (step 93). The user is free to zoom in to look at any part of the image more closely. A mole or skin lesion is selected for analysis in step 94. This lesion can be manually selected by the user by clicking on or around it, or the mole can be identified automatically by segmenting the image using any number of means (such as crude, binary thresholding, where a skin lesion is any group of pixels whose brightness is less than some cutoff; k-means or other expectation maximization algorithms, whereby objects in the image are grouped so as to minimize variance inside the groups; motivation or isodata thresholding, where the cutoff for a binary threshold is iteratively determined so as to threshold at the average of the means of the lesion group and non-lesion group; etc.) to find potential lesions. One goal of step 94 is to determine an approximate location of a lesion or several lesions. In routine 95, the margins (aka border) of the lesion(s) are determined by thresholding and/or region-growing. The margins can then be displayed to the user for approval. If the user is not satisfied with the results, the thresholding parameters can be changed or the margin can be drawn freehand by the user in step 96. Once the margins of the lesion(s) have been determined, in routine 97 the ABCDs of skin cancer are measured on the lesions(s) in question. In step 98, the results from the measurements are displayed for the user graphically (18) or stored (19).

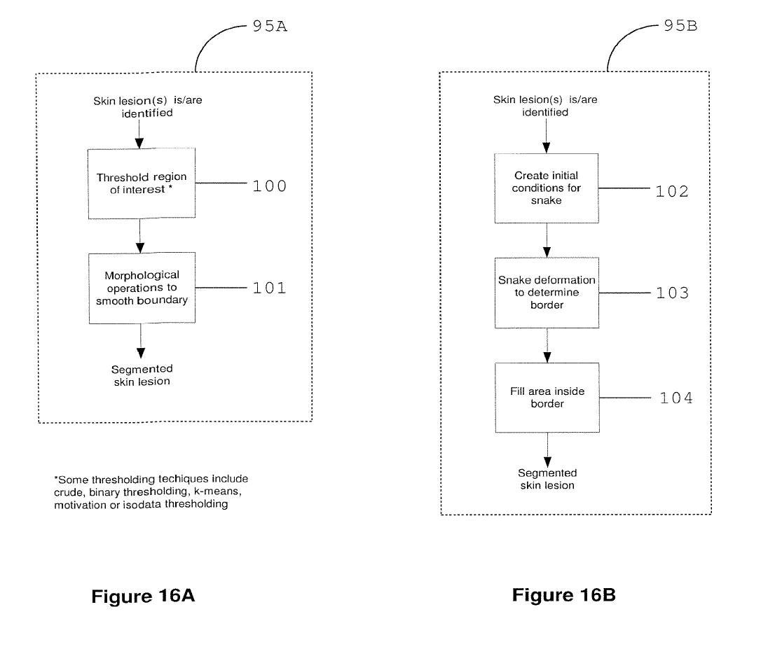

Two techniques for implementing routine 95 are illustrated in FIGS. 16A and 16B. FIG. 16A illustrates a simple technique: thresholding in a region of interest around the lesion then smoothing the boundary. The thresholding in step 100 is similar to that used to automatically identify lesions in 94. In some cases the same data produced in 94 may be reused in this step. Because there may be great variation in shading (e.g., shadows) in the entire image, however, thresholding just in a region of interest around the lesion yields better results. The margins produced by thresholding are sensitive to noise and may be rough; consequently, in step 101, the margins may be smoothed using morphological operations: filling to remove holes, then closure to smooth the margins. Other combinations of operators may produce similar results.

FIG. 16B illustrates a more sophisticated technique of segmenting a lesion that is less prone to noise. This technique uses active contours (“snakes”) to determine the margin of a lesion. In step 102, a starting point for the contour is determined. If the location of skin lesions was ascertained by user input, then the initial contour can be a simple circle around each location. The active contour algorithms work better, however, if the initial contour is closer to the actual border of the object to be segmented; steps 100 and 101 can thus also be used to generate the initial contour. In step 103, the contour is iteratively deformed using a gradient vector flow (GVF) active contour algorithm to determine the margins of the lesion. Other active contour algorithms could be substituted for GVF; however, GVF is used presently because of its high likelihood to converge to a satisfactory solution. The lesion includes the margin and the pixels inside it, the later of which are identified by flood-fill (labeling all contiguous pixels inside the margin, e.g., using the “paint bucket” fill found in graphics programs known to one of ordinary skill in the art) in step 104.

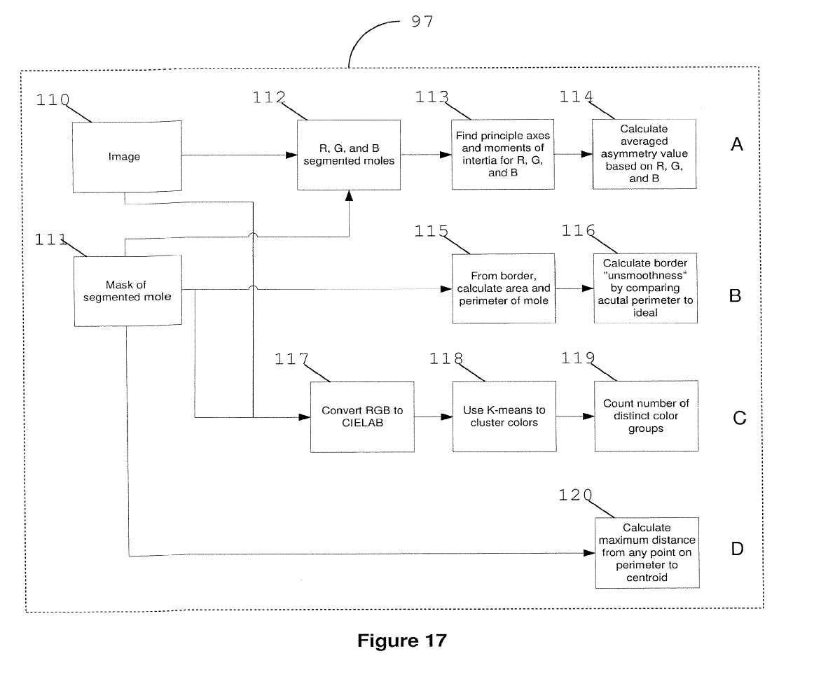

FIG. 17 illustrates a flowchart showing the details of how the ABCDs of skin cancer are measured in routine 97. Two images are used for these measurements: the image 110 and a mask 111 of the lesions segmented from the non-lesion remainder of the image. The latter is a binary image where the only nonzero pixels are those of lesion(s)—i.e., the product of step 101 or 104.

Asymmetry is calculated by comparing moments of inertia. For each of the three (red, green, and blue) components of the image, a segmented mole is created in step 112 by multiplying, pixel by pixel, the component image and mask. The principle axes and principle moments of inertia of each segmented mole component are calculated in step 113. In step 114, the principle moment of inertia about one side of the major axis is compared against that of the other side. If the particular color component is symmetric about the major axis, the two halves will have equal principle moments of inertia. A similar set of calculations occurs for the two sides of the mole created by bisection of the minor axis. The final asymmetry statistic is determined by normalizing the summed squares of the ratios of the half-moments of inertia for the color components. Note that eccentricity could be used as an alternate statistic for asymmetry.

The Border irregularity measurement is determined by calculating the area and perimeter of the lesion in step 115 from the mask image 111. The statistic, calculated in step 116 is the ratio of the actual perimeter to the ideal perimeter. The ideal perimeter is that of a circle whose area is that of the lesion. Alternatively, this statistic can be determined by other methods, such as counting the number of times the border changes direction-goes from closer to the center of the lesion to further away; this would effectively count the number of scalloped edges of the margin. Either some smoothing of the margin would be useful prior to looking at the direction of the margin to eliminate counts from small, minor nuances in the margin, or changes in direction would need to exceed a threshold.

The Color variegation statistic is determined by the number of distinct color groups in the mole. First, the masked mole is converted from an RGB image to a CIELAB image in step 117. The reason for this is to count colors in a perceptually linear color space. Groups of similar colors in the mole are clustered using K-means in step 118. Alternatively, the lesion's colors can be quantized (reducing the number of colors) into a standardized palette. Either way, there would be a relatively few number of colors represented in the lesion. The objects of concern are “color islands,” that is clusters of pixels with the same color, whose size is of significant. Consequently it is possible to either count the number of distinct color islands in the mole or calculate the length of the shortest curve including all the island's colors in CIELAB space (step 119), either of which makes a good Color statistic.

There are a few different ways for software to measure the Diameter statistic in step 120. The most conservative is to double the maximum distance from any point on the margin to the center of the mole. Alternatively, the statistic can be the maximum distance from a point of the margin to a point on the margin directly opposite the centroid from the former point. Yet another way to report the diameter is to calculate the effective diameter of the idealized mole that is a circle with area equal to that of the actual mole. Note that calculation requires that the scale of the image is known.

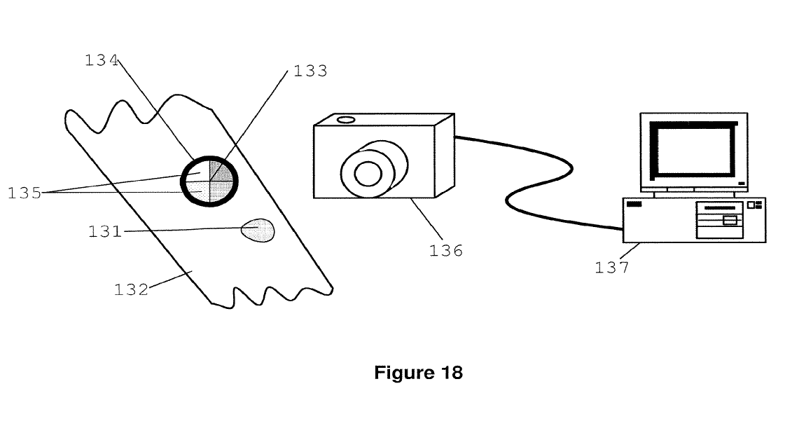

FIG. 18 shows an overview of a more sophisticated implementation of the inventive method and system. In the figure, there is a lesion 131 on the arm 132 of a person. A special marker 133 is positioned near the lesion. The marker serves as a reference for color and scale. Two noteworthy features of the marker are its having a known shape and dimension (the black ring 134) and having several patches 135 of solid colors (which can include white). The marker does not necessarily have to be a black ring with four quadrants of different colors (which is illustrated in FIG. 18); a square subdivided into smaller squares of different colors would work as well so long as the shape and distribution of color patches is known. The benefit to the circular shape of the marker in FIG. 18 is its relative ease in being pealed from wax paper backing. A digital camera 136 acquires an image of the skin with the marker and the image is transferred to a computing device 137. Again, there are several means for acquiring the image, transferring the image, and storing it, as discussed previously.

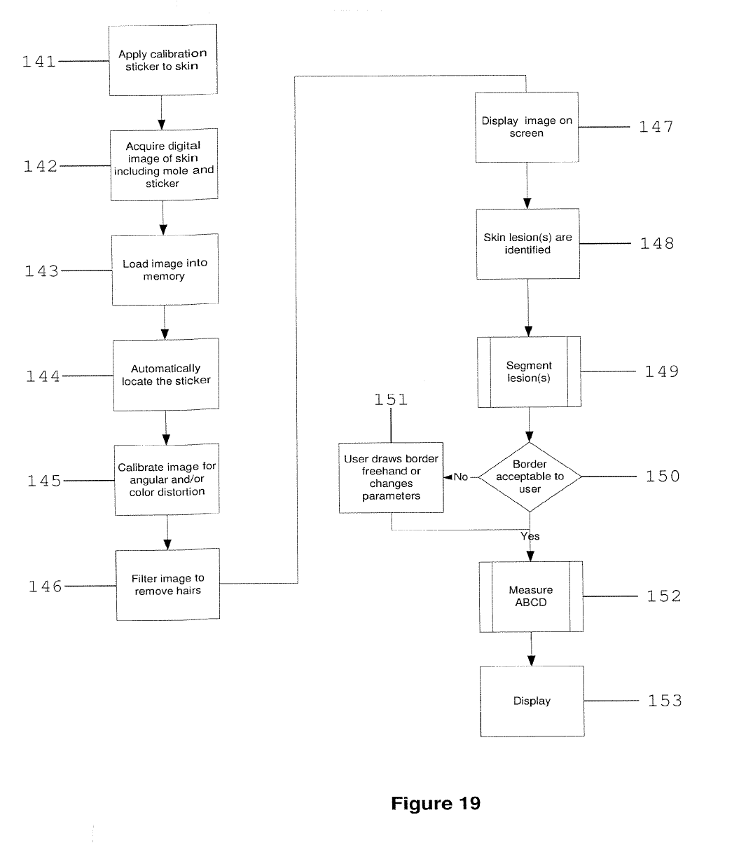

FIG. 19 shows that several new elements are added to the basic flowchart. These elements can be used altogether or “a la carte” without affecting the premise behind the inventive method and system. The first new element of the sophisticated implementation is the application of a sticker or other marker on the skin near the lesion to be photographed in step 141. The marker contains a circular (or other simple geometric) element 134. The purpose of the marker is to serve as a reference for the scale (for diameter measurements), angle between the camera and normal to the skin surface (for asymmetry and border measurements), and color in the image. See below for details on how these calibrations are performed.

After the image is acquired in step 142 and loaded into memory in step 143, the marker is automatically located in the image. The algorithm in step 144 looks for a region in the image that contains patches of the colors contained in the marker of known shape (e.g., circular). If the normal to the target was not directed right at the camera, the target (e.g., ring 134) will appear elliptical in the image. (If the target were square, the target would appear as a parallelogram.) Similarly, the image of the mole will be compressed in one direction. To correct this, the major and minor axes of the marker's element are measured. Then in step 145, the image is then skewed in the direction of the major axis so that the circular target appears symmetric.

The target contains several reference colors 135. These references are used to calibrate the color of the image to be true. This is particularly important if the camera and lighting are not controlled—which would occur if laypeople used their own cameras. Also in step 145, the image is converted from RGB to CIELAB. The L*, a*, and b* are linearly corrected so that the values match up with the references. Then, the image is converted back into RGB.

There may be hairs crossing the mole or portions of skin with glare (reflected light). In step 146, these artifacts may be digitally removed from the image prior to analyzing the mole. Hair appears as dark arcs in the image and clusters of glare are very bright. Pixels that are hair or glare can thus be identified by their being either darker or lighter, respectively, than those pixels in a neighborhood around them. Specifically, the image is lowpass filtered. If the absolute value of the difference between the pixel in the original image and in the filtered image is greater than a threshold, the value of that pixel is changed to that of the lowpassed image.

At this point, the image has been corrected for shape and color distortions, and pixel artifacts that could interfere with the ABCD measurements. The implementation of the inventive method and system can then proceed generally as before. The image is displayed (147), the lesion(s) are identified (148) and segmented (149). More or less user interaction can be part of the implementation. If the user is not happy with the automatic segmentation of the mole (step 150), the user can ask the system to try again using different initial conditions or draw the margin his or herself (151). The ABCDs of the lesion(s) are calculated (152) and are displayed and/or stored (153).

The inventive method and system provides a means for digitally measuring the ABCDs and presenting those results to a person. These data, however, may be used to present other descriptions of a skin lesion. For example, the changes in the ABCDs are part of the Seven Point Checklist. Change in any of the variables can be graphed as, for example, percent change. More significantly, the amount of change can be converted to likelihood of malignancy and displayed as described herein. The inventive method and system can thus be used to present the major signs of the Checklist. The minor signs can be determined by asking the person yes/no questions. The answers to the minor sign questions can be presented graphically by having no be a less-concerned value and yes be a more-concerned value. The more yeses, the closer to the more-concerned side all three measurements can be.

Another way to interpret skin lesions is to use the ABCDE rule, where E is evolution. Evolution corresponds to changes over time of ABC and D. As seen in FIG. 20, the inventive method and system can be extended to show, when comparing multiple images of a mole over time, the ABC and D of the most recent image, plus an E 160 that is derived from the amount of change in ABC and D in the time interval. One such implementation is the sum of percent changes in ABC and D. According to another exemplary embodiment, the evolution statistic can be calculated from an uneven weighting of ABC and D. The positioning of marker 160 can correspond to percent change or a likelihood of malignancy statistic derived from the evolution parameter E.

The dermatology community may come up with additional schemas to identify skin cancer. This inventive method and system should not be strictly limited to existing definitions of ABCD, but can be extended to other characterizations as well.

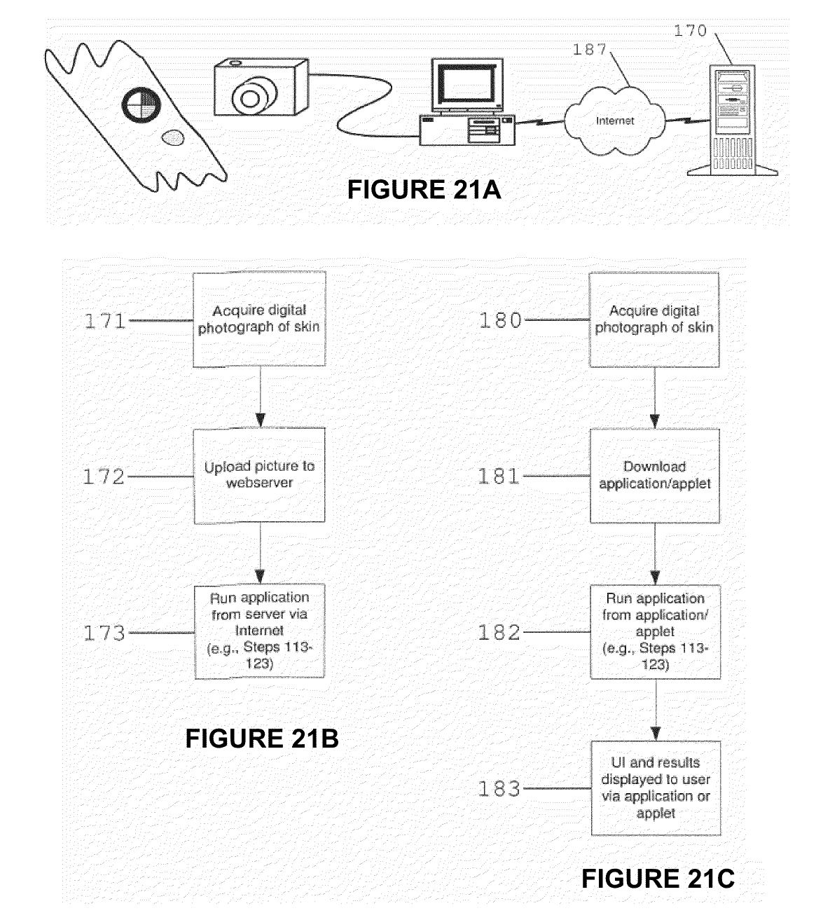

FIGS. 1 and 18 show a single PC as the computing and display device. There are other possible configurations of the inventive method and system. As mentioned before, the camera, computing device and display could be in one object, such a PDA. But there could also be more than one computer involved. For example, the inventive method and system can be embodied as a service on a dermatologist's website. A patient goes to the site, uploads to the server a skin image from his or her computer, and then the server returns to a web browser the measurements of any selected lesions. FIG. 21A shows internet (or network) 187 based implementations between a local computer and a networked computer or server (170). FIG. 21B illustrates an implementation where a digital picture is acquired at one location in step 171, and then is uploaded to a web or application server 172. The processing of the image is performed on the server and displayed via a web browser per step 173.

A different example is a patient going to a website, where he or she is prompted to download an applet. The analysis of the skin lesion this occurs in the applet inside the patient's web browser. This second example has the benefit that a patient does not have complete control of the inventive method and system and the computing resources are on the patient's computer rather than at a server. In FIG. 21C, a web application or applet is downloaded (step 181) from a server to a computer where a user loads the image into memory locally. A person acquires an image (180), downloads the application or applet (181), runs the application or applet locally where the image is loaded into memory in step 182, and eventually results are displayed (183). Other technologies for running applications over the internet or other networks may be invented and this basic system for using the inventive method and system can be extended to those technologies.

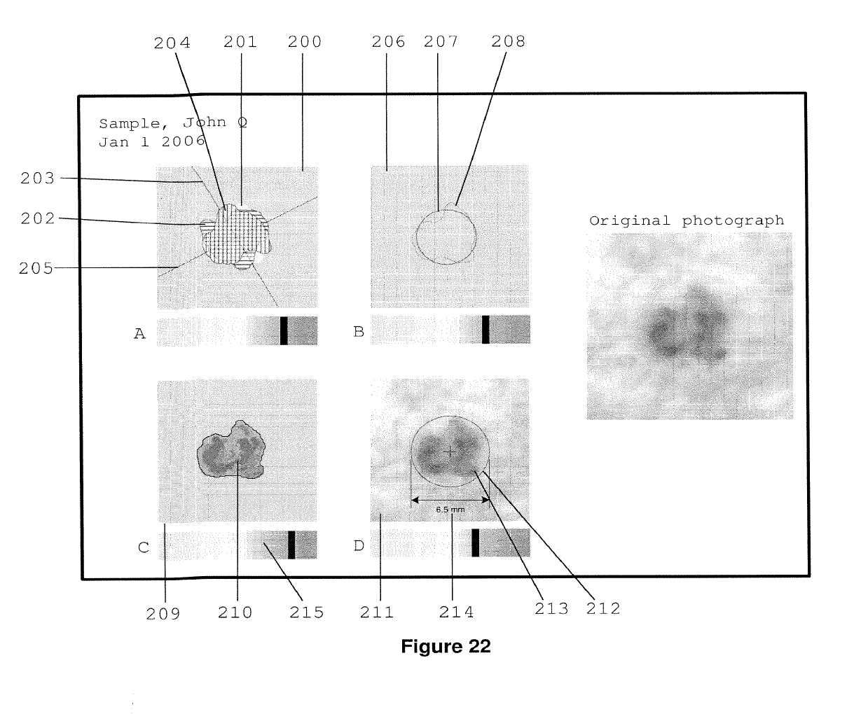

FIG. 22 shows a user interface where the parameters are graphically explained according to one exemplary embodiment of the invention. Picture 200 illustrates how the Asymmetry parameter was calculated. The white blob 201 is the segmented lesion (refer to object 111). Blob 202 (illustrated with horizontal hatches) represents the lesion mirrored across principal axis 203. Blob 204 (illustrated with vertical hatches) represents the lesion mirrored across principal axis 205. The hatching in the illustration is for purposes of clarity; in the user interface, the blobs can be semi-transparent colors such as yellow and blue. From the picture 200 it can be seen how the lesion is not symmetric about its principal axes. Picture 206 illustrates how the border parameter was derived by showing how the border 208 of the lesion is longer than the circle 207 whose area is identical to that of the lesion and is centered at the centroid of the lesion. Picture 209 illustrates how the color parameter was calculated. Blob 210 shows the lesion after the colors have been grouped together. In the example, it can be seen that there are several different colors in this lesion. Picture 211 illustrates how the diameter parameter was determined. Circle 212 is the smallest circle centered at the centroid of the lesion that completely encloses the lesion. The border 213 of the lesion is shown for comparison. Label 214 displays the diameter of the circle. The bars, such as the one for color 215, are displayed next to the pictures.

Alternative embodiments of the inventive method and system will become apparent to one of ordinary skill in the art to which the present invention pertains without departing from its spirit and scope. Thus, although this invention has been described in exemplary form with a certain degree of particularity, it should be understood that the present disclosure has been made only by way of example and that numerous changes in the details of construction and the combination and arrangement of equipment, parts or steps may be resorted to without departing from the spirit or scope of the invention.

What is claimed is:

1. A method for assisting a user to quantify the risk factors for melanoma in a skin lesion comprising:
acquiring a digital image of the skin lesion;
displaying the digital image of the skin lesion on a display device;
determining the margins of the skin lesion;
calculating skin parameter values for asymmetry, border irregularities, color variegation, and diameter of the skin lesion; and
displaying the calculated skin parameter values.

2. The method of claim 1, further comprising displaying calculated skin parameter values and older skin parameter values of like categories in a single bar graph.

3. The method of claim 1, further comprising displaying terms for the end points on graphs containing the calculated skin parameter values that indicate relative risks associated with the skin lesion.

4. The method of claim 1, further comprising displaying the margins of the skin lesion on a display device.

5. A method for assisting a user to determine if changes have occurred in a skin lesion comprising:
acquiring a digital image of the skin lesion;
displaying the digital image of the skin lesion on a display device;
determining the margins of the skin lesion;
calculating skin parameter values for asymmetry, border irregularities, color variegation, and diameter of the skin lesion; and
displaying the calculated skin parameter values and older skin parameter values measured for the skin lesion.

6. The method of claim 5, further comprising displaying calculated skin parameter values and older skin parameter values of like categories in a single bar graph.

7. The method of claim 5, further comprising displaying terms for the end points on graphs containing the calculated skin parameter values that indicate relative risks associated with the skin lesion.

8. The method of claim 5, further comprising displaying the margins of the skin lesion on a display device.
